(19) United States
(12) Patent Application Publication
(10) Pub. No.: US 2022/0092567 A1
(43) Pub. Date: Mar. 24, 2022

(54) SELF-SERVICE SHOPPING SYSTEM AND METHOD FOR OPERATING THE SAME

(71) Applicant: ELO TOUCH SOLUTIONS, INC., MILPITAS, CA (US)

(72) Inventors: Yin SUN, SHANGHAI (CN); Jinfeng ZHANG, SHANGHAI (CN); Xueqing WEI, SHANGHAI (CN); Hua SHAO, SHANGHAI (CN)

(73) Assignee: ELO TOUCH SOLUTIONS, INC., MILPITAS, CA (US)

(21) Appl. No.: 17/425,486

(22) PCT Filed: Apr. 22, 2020
(86) PCT No.: PCT/US2020/029215

§ 371 Date: Jul. 23, 2021

(30) Foreign Application Priority Data
Apr. 25, 2019 (CN) 201910336407.4

(51) Int. Cl. G06Q 20/18; G06Q 20/20

(52) U.S. Cl. CPC G06Q 20/18; G06Q 20/208

(57) ABSTRACT

The present invention relates to a method for operating a self-service shopping system. The method includes: identifying a product code on a chosen product; determining whether the chosen product has an alterable tag; if the product code on the chosen product is identified and the chosen product is determined to carry a tag, altering the tag on the chosen product; and when the product code on the chosen product carrying altered tag are identified again, allowing the user to reduce the number of the chosen product carrying the altered tag through an interactive interface of the self-service shopping system or store staff. In addition, the present invention also relates to a self-service shopping system. The self-service shopping system includes an identification module, an analysis processing module, an altering module, and a feedback module. The method for operating a self-service shopping system and the self-service shopping system according to the present invention can improve the user experience and the anti-theft reliability.

### CROSS-REFERENCE TO RELATED APPLICATIONS

This application claims the benefit of the filing date of, Chinese application number 201910336407.4, filed Apr. 25, 2019, entitled “SELF-SERVICE SHOPPING SYSTEM AND METHOD FOR OPERATING THE SAME,” which application is incorporated by reference herein in its entirety.

### TECHNICAL FIELD

The present invention relates to methods for operating self-service shopping systems and the self-service shopping systems.

### BACKGROUND ART

At present, with the development of network payment technology and cloud service, self-service shopping stores have received more and more attention in the field of electronic commerce. However, due to technical limitations, the application of the self-service shopping stores is still very limited nowadays.

More and more retailers are paying attention to measures to effectively prevent products from being stolen. In this regard, a common measure adopted currently is the use of EAS (Electronic Article Surveillance). An operation mode of the EAS is as follows: a tag is attached to a product and a detector is installed at the exit passage of a mall; for the paid-up products, the tags thereon are degaussed by a degaussing device, while for the unpaid products or the products not degaussed, when they pass the exit, the tags thereon may be detected by the detector at the gateway, which then raises an alarm to intercept the product.

Although the existing EAS can effectively prevent the loss of products to some extent, there are still a series of security loopholes to be solved. In addition, the user experience needs to be improved as well.

### CONTENT OF THE INVENTION

Thus, an object of the present invention is to provide a method for operating a self-service shopping system and the self-service shopping system capable of overcoming at least one drawback in the prior art.

According to a first aspect of the present invention, there is provided a method for operating a self-service shopping system. The method includes:

identifying a product code on a chosen product;

determining whether the chosen product carries a tag;

if the product code on the chosen product is identified and the chosen product is determined to carry a tag, altering the tag on the chosen product;

when the product code on the chosen product carrying the altered tag is identified again, allowing a user to reduce the number of the chosen product carrying the altered tag through an interactive interface of the self-service shopping system or store staff.

It should be noted that the method steps in the embodiments of the present invention may be implemented by different modules. These modules are combined to form the self-service shopping system of the present invention. According to the present invention, the product code on the chosen product may be a graphic code such as a barcode or a two-dimensional code. The tag on the chosen product may be a soft tag such as an electronic tag, or may be a hard tag such as a magnetic stripe tag or an acousto-magnetic tag. In addition, the tag may be constructed as an RFID electronic tag. Conceptually, RFID is similar to the barcode. With respect to the technology of barcodes, it involves attaching an encoded barcode to a target object, and using a dedicated scanning reader to transmit information from the barcode to the scanning reader by optical signals. With respect to the RFID, it involves the use of a dedicated RFID reader and a dedicated RFID tag attachable to the target object, and using RF signals to transmit information from the RFID tag to the RFID reader, with no need to establish a mechanical or optical contact between an identification system and the specific target.

The tag in the present invention needs to cooperate with the anti-theft detector in the store. If the tag is not altered, for example, a magnetic stripe tag is not degaussed, so far as the tag passes or approaches an anti-theft detector in the store (which is typically installed near the exit of the store), the anti-theft detector may detect the presence of the tag, thereby triggering an alarm system to prevent the product carrying this tag from being taken out of the store. However, once the tag has been altered, it means that the anti-theft detector is unable to detect the presence of the tag any more, allowing the product to be taken out of the store arbitrarily. The technical solution according to the present invention can effectively prevent the products from being stolen, improve the reliability of the self-service shopping system, and improve the user experience.

According to the present invention, the user is prohibited from reducing the number of the chosen product carrying the altered tag through the interactive interface of the self-service shopping system before the product code on the chosen product carrying the altered tag are identified again. In this way, the chosen products are prevented from being intentionally stolen.

In some embodiments, the step of identifying a product code on a chosen product includes identifying, by scanning, the product code on the chosen product.

In some embodiments, the step of determining whether the chosen product carries a tag includes detecting, by means of a tag detector, whether the chosen product carries a tag.

In some embodiments, the method further includes: if the product code on the chosen product is identified and the chosen product is determined to carry no tag, allowing the chosen product to be priced.

In some embodiments, the method further includes: identifying a tag code on the chosen product, and altering the tag on the chosen product if the product code and the tag code on the chosen product are both identified.

In some embodiments, the step of identifying a tag code on the chosen product includes identifying, by scanning, the tag code on the chosen product.

In some embodiments, the step of altering the tag on the chosen product if the product code and the tag code on the chosen product are both identified includes: checking, based on database, whether the product code and tag code identified have a correspondence relationship, and if so, altering the tag on the chosen product, or otherwise, feeding a result of altering failure back to a user and/or store staff. Such check of the correspondence relationship between the product code and the tag code based on database can effectively prevent artificial tampering of the tag ought to be altered or degaussed. This further improves the security of the system. According to the present invention, the database may be a local database of the self-service shopping system, or may be a cloud database, in which attribute information, such as price, weight, manufacturer, shelf life, raw materials, and the like of the chosen product, is stored.

In some embodiments, said method further includes: performing another identification at least once if at least one of the product code and the tag code on the chosen product fails to be identified; and

feeding a result of altering failure back to a user and/or store staff if the product code and the tag code on the chosen product still fail to be identified after a first predetermined time interval.

In some embodiments, said method further includes: performing another identification at least once if the product code on the chosen product is identified while the tag code on the chosen product fails to be identified; and

determining the chosen product to carry no tag if the tag code on the chosen product still fails to be identified after a second predetermined time interval, and allowing the chosen product to be priced.

In some embodiments, said method further includes: performing another identification at least once if the chosen product is determined to carry a tag but the product code on the chosen product fails to be identified; and

feeding a result of altering failure back to a user and/or store staff if the product code on the chosen product still fails to be identified after a third predetermined time interval.

In some embodiments, the method further includes: checking the altering result of the tag after altering, and if the altering fails, altering the tag at least one once, if it still fails, determining the tag is invalid, and notifying the store staff to change the invalid tag; if it works, allowing the chosen product to be priced. This may effectively avoid altering failures due to invalidation of the tags.

It should be noted that the first predetermined time interval, the second predetermined time interval, and the third predetermined time interval in the present invention may be flexibly selected according to the specific application situation.

In some embodiments, the product code and the tag code on the chosen product are configured as at least one code disposed on the tag.

In some embodiments, the step of altering the tag on the chosen product if the product code and the tag code on the chosen product are both identified include:

determining, based on database, whether the chosen product corresponding to the code carries a tag;

altering the tag on the chosen product if the chosen product is determined to carry a tag; and if the chosen product is determined to carry no tag, feeding a result of altering failure back to a user and/or store staff.

In some embodiments, said method further includes: if the product code on the chosen product is identified and the chosen product is determined to carry no tag, allowing the user to alter the number of the chosen products carrying no tag through the self-service shopping system.

the method further includes restoring the anti-theft function of the tag of the retrieved chosen product carrying altered tag.

In some embodiments, said method further includes: if the user has increased the number of the chosen product carrying the altered tag, notifying the user to scan the increased chosen product so as to alter the tag of the increased chosen product.

In some embodiments, said method further includes: checking the altering result of the tag after altering, and if the altering fails, altering the tag at least one once,

if it still fails, determining the tag is invalid, and notifying the store staff to change the invalid tag; if it works, allowing the chosen product to be priced.

In some embodiments, the method further includes feeding the user's operation result back to the user and/or store staff via voice output and/or visual output. In particular, the reduced product name and its quantity may be fed back to the user and/or store staff.

According to a second aspect of the present invention, there is provided a self-service shopping system. The self-service shopping system comprises: an identification module, an analysis processing module and an altering module, wherein

the identification module is configured to identify a product code on a chosen product, and transmit identification data to the analysis processing module;

the analysis processing module is configured to:
determine whether the chosen product carries a tag;
transmit an altering command to the altering module when the identification module successfully identifies the product code on the chosen product and the analysis processing module determines that the chosen product carries a tag;
allow the user to reduce the number of the chosen product carrying altered tag through an interactive interface of the self-service shopping system or store staff when the identification module successfully identifies again the product code on the chosen product carrying the altered tag; and

the altering module is configured to alter the tag on the chosen product based on the altering command of the analysis processing module.

It should be noted that the identification module, the analysis processing module and the altering module in the self-service shopping system of the present invention are exemplary modules divided functionally. In actual application, the self-service shopping system may be divided into more or fewer modules. Further, the modules may also be combined with each other or may be divided further. For example, the identification module and the altering module may be configured as one module. For example, in the case of an RFID electronic tag, the identification module and the altering module may both be configured as an RFID reader. In addition, the analysis processing module may also be further divided into a upper communication module and a lower communication module, both of which allow bidirectional transmission therebetween by means of commands. The upper communication module may be a module with an operating system, and the user may perform human-computer interaction, such as checkout, altering quantity, deletion, and the like on the upper communication module. The lower communication module functions as a mediation module to get direct signal connection with external devices, such as the identification module and the altering module. Such a system architecture is advantageous in that it can simplify the design of the upper communication module and integrate more functions into the lower communication module, which also makes the entire system more flexible in design and more abundant in function.

In some embodiments, the self-service shopping system further comprises a feedback module operated and controlled by the analysis processing module such that the feedback module feeds the user's operation result back to the user and/or store staff via voice output and/or visual output.

In some embodiments, the identification module comprises a scanner.

In some embodiments, the self-service shopping system has a tag detector configured to detect the tag on the chosen product and transmit a detection signal to the analysis processing module, which, based on the detection signal, determines whether the chosen product carries a tag. In some embodiments, if the identification module successfully identifies the product code on the chosen product and the analysis processing module determines that the chosen product carries no tag, the analysis processing module allows the chosen product to be priced.

In some embodiments, the identification module is further configured to identify a tag code on the chosen product, and the analysis processing module is further configured such that if the identification module successfully identifies the product code and the tag code on the chosen product, the altering module alters the tag on the chosen product.

In some embodiments, the analysis processing module checks, based on database, whether the product code and tag code identified have a correspondence relationship, and if so, the altering module alters the tag on the chosen product, or otherwise, the altering operation fails.

In some embodiments, the identification module is configured to perform another identification at least once if it fails to identify at least one of the product code and the tag code on the chosen product; and

if the product code and the tag code on the chosen product still fail to be identified after a first predetermined time interval, the altering operation fails, and the analysis processing module controls the feedback module such that the feedback module feeds the information on failure of altering back to the user and/or store staff via voice output and/or visual output.

In some embodiments, the identification module is configured to perform another identification at least once if it successfully identifies the product code on the chosen product but fails to identify the tag code on the chosen product; and

if the tag code on the chosen product still fails to be identified after a second predetermined time interval, the analysis processing module determines the chosen product to carry no tag, and allows the chosen product to be priced.

In some embodiments, the analysis processing module is configured to send a control command to prompt the identification module to perform another identification at least once if the chosen product is determined to carry a tag but no identification data is received; and

if the identification data still fails to received after a third predetermined time interval, the altering operation fails.

In some embodiments, the product code and the tag code on the chosen product are configured as at least one code disposed on the tag.

In some embodiments, the analysis processing module determines, based on database, whether the chosen product corresponding to the code carries a tag; and

if the chosen product is determined to carry a tag, the altering module alters the tag on the chosen product, and if the chosen product is determined to carry no tag, the altering operation fails.

In some embodiments, the analysis processing module is configured to allow the user to alter the number of the chosen products carrying no tag through the self-service shopping system if no identification data is received and the chosen product is determined to carry no tag.

In some embodiments, the self-service shopping system further includes a retrieving device configured to retrieve the chosen product carrying the altered tag.

In some embodiments, the tag detector is integrated with the altering module as a tag identification altering device.

In some embodiments, if the user has increased the number of the chosen product carrying the altered tag, the feedback module notifies the user to scan the increased chosen product so as to alter the tag of the increased chosen product.

According to a third aspect of the present invention, there is provided a method for operating a self-service shopping system. The method includes:

receiving identification data of a product code on a chosen product;

determining whether the chosen product carries a tag;

if the identification data of the product code on the chosen product is received and the chosen product is determined to carry a tag, sending an altering command to alter the tag on the chosen product; and

when the identification data of the product code on the chosen product carrying altered tag is received again, sending an unlocking command to a upper communication module to allow a user to reduce the number of the chosen product carrying the altered tag through an interactive interface of the self-service shopping system or store staff.

In some embodiments, the step of determining whether the chosen product carries a tag includes receiving a detection signal of a tag detector for detecting whether the chosen product carries a tag.

In some embodiments, the method further includes: if the product code on the chosen product is received and the chosen product is determined to carry no tag, sending a command to the upper communication module to allow the chosen product to be priced.

In some embodiments, the method further includes: receiving identification data of a tag code on the chosen product, and if the identification data of the product code and the identification data of the tag code on the chosen product is received, sending a command to the lower communication module to alter the tag on the chosen product.

In some embodiments, the step of, if the identification data of the product code on the chosen product is received and the chosen product is determined to carry a tag, sending an altering command to alter the tag on the chosen product includes: if the received identification data of the product code and identification data of the tag code on the chosen product have a correspondence relationship, sending an altering command to alter the tag on the chosen product; and if no corresponding relationship is present therebetween, sending a control signal to feed a result of altering failure to a user and/or store staff.

In some embodiments, said method further includes:

sending a command to the lower communication module to cause the lower communication module to perform another identification at least once if at least one of the identification data of the product code and the identification data of the tag code on the chosen product fails to be identified; and

sending a control signal to feed a result of altering failure to a user and/or store staff if the identification data of the product code and the identification data of the tag code on the chosen product still fail to be received after a first predetermined time interval.

In some embodiments, said method further includes:

sending a command to the lower communication module to cause the lower communication module to perform another identification at least once if the identification data of the product code on the chosen product is received while the identification data of the tag code on the chosen product fails to be received; and

determining the chosen product to carry no tag if the identification data of the tag code on the chosen product still fails to be received after a second predetermined time interval, and then sending a command to the upper communication module to allow the chosen product to be priced.

In some embodiments, said method further includes:

sending a command to the lower communication module to cause the lower communication module to perform another identification at least once if the chosen product is determined to carry a tag carry a tag but no identification data of the product code on the chosen product is received; and

sending a control signal to feed a result of altering failure to a user and/or store staff if the identification data of the product code on the chosen product still fails to be received after a third predetermined time interval.

In some embodiments, the product code and the tag code on the chosen product are configured as at least one code disposed on the tag.

In some embodiments, the step of, if the identification data of the product code on the chosen product is received and the chosen product is determined to carry a tag, sending an altering command to alter the tag on the chosen product includes:

sending a command to the lower communication module to control altering of the tag on the chosen product if the chosen product corresponding to the code is determined to carry a tag; and if the chosen product is determined to carry no tag, sending a control signal to feed a result of altering failure to a user and/or store staff.

In some embodiments, said method further includes:

if the identification data of the product code on the chosen product is received and the chosen product is determined to carry no tag, sending a command to the upper communication module to allow the user to alter the number of the chosen products carrying no tag through the interactive interface of the self-service shopping system.

In some embodiments, said method further includes: if the user has reduced the number of the chosen product carrying the altered tag, sending a control signal to notify the store staff of retrieval.

In some embodiments, said method further includes: if the user has increased the number of the chosen product carrying the altered tag, sending a control signal to notify the user to scan the increased chosen product so as to alter the tag of the increased chosen product.

In some embodiments, said method further includes: checking the altering result of the tag after altering, and if the altering fails, prompting at least one altering again,

if it still fails, determining the tag is invalid, and sending a control signal to notify the store staff to change the invalid tag; if it works, sending a control signal to allow the chosen product to be priced.

According to a fourth aspect of the present invention, there is provided a data processing device comprising: a memory in which computer executable commands are stored; and a processor configured to execute the computer executable commands, wherein the processor, when executing the commands, implements the method according to the present invention.

According to the present invention, the data processing device may be constructed as a module in the self-service shopping system. For example, it may be constructed as a sub-module in the analysis processing module, such as the lower communication module as described above, which communicates bidirectionally with the upper communication module of the analysis processing module.

According to a fifth aspect of the present invention, there is provided a computer readable storage medium storing computer executable commands therein which, when executed by a processor, implements the method according to the present invention.

Embodiments of the present invention may be implemented in hardware or in software according to actual requirements. The embodiments may be implemented in the case of use of a digital storage medium such as a floppy disk, DVD, Blu-ray Disc, CD, ROM, PROM, EPROM, EEPROM or flash memory, solid state drive or other magnetic or optical memories, where an electronically readable control signal is stored on the digital storage medium, and the control signal can cooperate with programmable hardware components in such a manner that the corresponding method is implemented.

The programmable hardware components may include processors, central processing units (CPUs), graphics processing units (GPUs), computers, computer systems, application specific integrated circuits (ASICs), integrated circuits (ICs), system-on-a-chip (SOC), programmable Logic components or field programmable gate arrays (FPGAs) with microprocessors.

Thus, a computer readable storage medium may be machine readable or computer readable. Accordingly, in some embodiments, the computer readable storage medium includes a data carrier having executable commands that are capable of interacting with the programmable computer system or the programmable hardware component such that one of the methods described herein is implemented. Thus, one embodiment is a data carrier, a digital storage medium or a computer readable storage medium, and on the data carrier is recorded a program for implementing one of the methods described herein.

Embodiments of the present invention may generally be implemented as a program, firmware, computer program, or computer program product with program code, or as data, where the program code or data effectively implements the method when the program is executed on a processor or a programmable hardware component. The program code or data may also, for example, be stored on a machine readable carrier or data carrier. The program codes or data may additionally be present as source codes, machine codes or bytecodes, and as other intermediate codes.

Moreover, another embodiment is a data stream, a signal sequence, or a signal series, which is a program for implementing one of the methods described herein. The data stream, signal sequence or signal series may, for example, be configured for transmission via a data communication connection, such as via the Internet or other networks. Thus, an embodiment may also be a signal sequence representing data that is suitable for transmission via a network or data communication connection, wherein the data is a program.

### BRIEF DESCRIPTION OF THE DRAWINGS

After reading the embodiments below in combination with the drawings, a plurality of aspects of the present invention will be better understood. In the drawings:

FIG. 1 is a schematic block diagram showing a self-service shopping system according to the present invention;

FIG. 2 is a schematic flow chart showing a method for operating a self-service shopping system according to a first embodiment of the present invention;

FIG. 3 is a schematic flow chart showing a method for operating a self-service shopping system according to a second embodiment of the present invention;

FIG. 4 is a schematic flow chart showing a method for operating a self-service shopping system according to a third embodiment of the present invention;

FIG. 5 is a schematic flow chart showing a method for operating a self-service shopping system according to a fourth embodiment of the present invention.

### EMBODIMENTS

Embodiments of the present invention will be described below with reference to the drawings, in which several embodiments of the present invention are shown. It should be understood, however, that the present invention may be implemented in many different ways, and is not limited to the example embodiments described below. In fact, the embodiments described hereinafter are intended to make a more complete disclosure of the present invention and to adequately explain the scope of the present invention to a person skilled in the art. It should also be understood that, the embodiments disclosed herein can be combined in various ways to provide many additional embodiments.

It should be understood that, the wording in the specification is only used for describing particular embodiments and is not intended to limit the present invention. All the terms used in the specification (including technical and scientific terms) have the meanings as normally understood by a person skilled in the art, unless otherwise defined. For the sake of conciseness and/or clarity, well-known functions or constructions may not be described in detail.

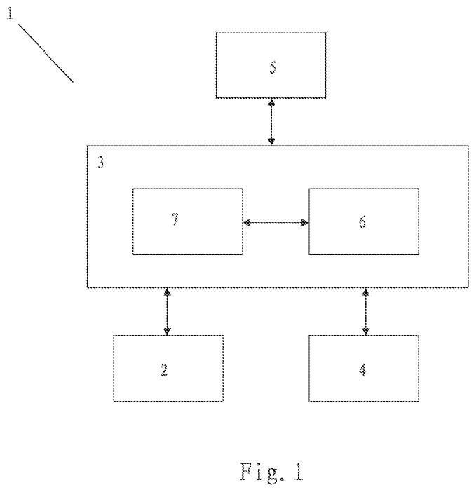

FIG. 1 is a schematic block diagram of a self-service shopping system according to the present invention. As shown in FIG. 1, a self-service shopping system 1 includes an identification module 2, an analysis processing module 3, an altering module 4, and a feedback module 5. In this embodiment, the identification module 2 is constructed as a scanning device and configured to identify a product code, such as a graphic code, on a chosen product, and to transmit the identified data to the analysis processing module 3. In other embodiments, the identification module 2 may also be configured as other identification devices, such as a camera, a code reader, an RFID reader, and the like.

As can be seen from FIG. 1, the analysis processing module 3 comprises two sub-modules: a control module 6 and an operation module 7. The control module 6 and the operation module 7 communicate with each other by means of commands. The control module 6 includes at least a processor and a memory, wherein the memory stores computer executable commands therein, and the processor is configured to execute the computer executable commands. The control module 6 receives data from an external device, such as identification data from the identification module 2. In addition, the control module 6 may also control external devices, for example, control the feedback module 5 to perform voice feedback or control the altering module 4 to carry out altering operation. The operation module 7 may be configured to have an operating system such as an Android system or a Windows system. The user may carry out human-machine interaction with the self-service shopping system 1 on the operation module 7. In this embodiment, the operating module 7 and the control module 6 may each be configured as a separate unit, and the operation module 7 serves as a upper communication module of the control module 6, and receives a command from the control module 6 or transmits a command to the control module 6. Thus, the operation module 7 is able to communicate with the external devices via the control module 6. It should be noted that although the analysis processing module 3 is mentioned generally for some functions in the present application, the module that specifically performs the function may be the control module 6 or the operation module 7. In other embodiments, the control module 6 and the operation module 7 may also be integrated into one module. In this case, the control module 6 and the operation module 7 are no longer distinguished between the upper communication module and the lower communication module. Of course, the analysis processing module 3 may also include more sub-modules for implementing different functions respectively.

In this embodiment, the altering module 4 is configured to receive an altering command from the analysis processing module 3 to alter the tag on the chosen product so that the anti-theft detector may no longer be able to detect the tag. The current tags mainly include: anti-theft magnetic stripes, acousto-magnetic tags, radio frequency tags, RFID electronic tags, and the like. With respect to the anti-theft magnetic stripes and the acousto-magnetic tags, the altering module 4 may be configured as a degaussing device. When the chosen product is placed within the magnetic radiation area of the degaussing device to be degaussed, magnetic stripe information is altered, so that the anti-theft detector may no longer be able to detect the tag. With respect to the radio frequency tags and the RFID electronic tags, the altering module 4 may be configured as an RFID reader, through which pricing may be performed directly and information of the RFID electronic tag on the priced product may be re-written. Of course, it is also possible to envisage other altering modules 4 that can modify the characteristics of the tag, so that the anti-theft detector can effectively detect the chosen products carrying unaltered tags.

In this embodiment, the feedback module 5 includes an LED display and a speaker. The analysis processing module 3 sends a command to the corresponding feedback module 5 so that the user's operation results (code-scanning failure, code-scanning success, degaussing failure, degaussing success, payment failure, payment success, etc.) are fed back to the user and/or store staff via voice or image. Of course, the feedback module 5 may also be designed as other visual and audible feedback modules.

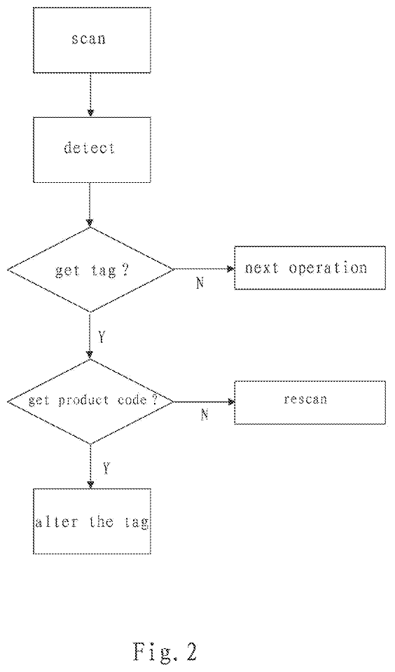

Next, a method for operating a self-service shopping system 1 according to the present invention will be described in detail with reference to FIGS. 2 to 5.

FIG. 2 is a schematic flow chart showing a method for operating a self-service shopping system 1 according to a first embodiment of the present invention. In this first embodiment, the self-service shopping system 1 has a tag detector, which may be integrated on the altering module 4, whereby the altering module 4 may be regarded as a tag identification altering module being able to detect the presence of the tag and alter the tag. With respect to the anti-theft magnetic stripes and the acousto-magnetic tags, the tag detector may be constructed as a detection coil. For example, when an anti-theft magnetic stripe is placed within the area of the detection coil, the detection coil may generate an electrical signal based on electromagnetic induction and transmit the electrical signal to the analysis processing module 3. The detection coil may be mounted, for example, around the identification module 2. When a user scans the product code on the chosen product, the detection coil may detect immediately the tag on the chosen product and send a detection signal to the analysis processing module 3. The analysis processing module 3 determines, based on the detection signal, whether the chosen product carries a tag or not. Of course, the detection coil may also be placed in other areas. With respect to the radio frequency tags and the RFID electronic tags, the tag detector may also be constructed as an electronic tag detector.

After having chosen products, the user comes to checkout. The identification module 2 sequentially identifies the product codes on the chosen products, and transmits identification data of the identified product codes to the analysis processing module 3. The analysis processing module 3 extracts attribute information of the chosen products, such as price, weight, etc., based on the received identification data. The attribute information may be stored in a local database or a cloud database.

When a chosen product carries no tag, the analysis processing module 3 allows the next operation, such as pricing and checkout. When a chosen product carries a tag, the tag detector may detect the presence of the tag and send the detection signal to the analysis processing module 3, and the analysis processing module 3 determines, based on the received detection signal, that the chosen product carries a tag. When the analysis processing module 3 receives the identification data of the product code on the chosen product and the detection signal from the tag detector, the analysis processing module 3 sends a altering command to the altering module 4 to prompt the altering module 4 to alter the tag on the chosen product, for example, degauss the magnetic stripe or re-write the RFID tag, thereby enabling smooth checkout of the chosen product and allowing it to be taken out of the store.

However, there are some potential problems existing in the above process. For example, when the user inadvertently blocks the tag or the product code, the process may be interrupted, causing failure of checkout or altering.

When the user inadvertently blocks the product code, the identification module 2 is unable to identify the product code on the chosen product, and accordingly the analysis processing module 3 is unable to obtain the identification data of the product code on the chosen product. The analysis processing module 3 may send a corresponding command to the feedback module 5. The feedback module 5 may remind the user “DO NOT BLOCK; RESCAN”, for example, by voice.

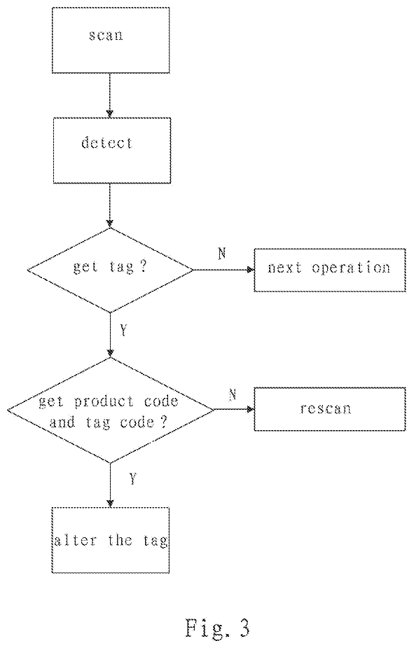

Referring to FIG. 3, when the user inadvertently blocks the tag, where a method for operating the self-service shopping system 1 according to a second embodiment of the present invention is shown. In the second embodiment, the tag is provided with a tag code which can likewise be identified by the identification module 2.

In the second embodiment, the identification module 2 sequentially identifies the product code and the tag code on the chosen product, and transmits the identification data of the product code and the identification data of the tag code to the analysis processing module 3. The analysis processing module 3 extracts attribute information of the chosen products, such as price, weight, etc., based on the received identification data. The attribute information may be stored in a local database or a cloud database. When the chosen product does not carry a tag, the analysis processing module 3 allows the next operation, such as pricing and checkout.

When the chosen product carries a tag, the tag detector may detect the presence of the tag and send the detection signal to the analysis processing module 3, and the analysis processing module 3 determines, based on the received detection signal, that the chosen product carries a tag. When the analysis processing module 3 receives the detection signal from the tag detector and also receives the identification data of the product code and the identification data of the tag code on the chosen product, the analysis processing module 3 sends an altering command to the altering module 4 to prompt the altering module 4 to alter the tag on the chosen product, for example, degauss the magnetic stripe or re-write the RFID tag, thereby enabling smooth checkout of the chosen product and allowing it to be taken out of the store. Otherwise, if the analysis processing module 3 fails to receive the identification data of the product code and/or the identification data of the tag code on the chosen product, the analysis processing module 3 sends a corresponding command to the feedback module 5. The feedback module 5 may remind the user “RESCAN” or “DEGAUSSING FAILS; DO NOT BLOCK THE TAG”, for example, by voice. Thus, the problem that the tag is blocked can be effectively solved.

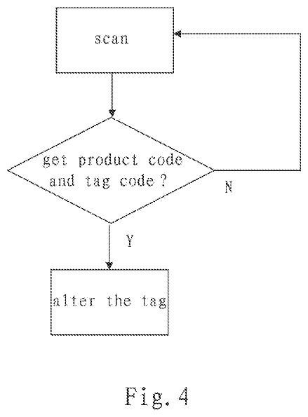

Next, a method for operating the self-service shopping system 1 according a third embodiment of the present invention is shown with reference to FIG. 4. In the third embodiment, the self-service shopping system 1 does not have a tag detector, but the tag is still provided with a tag code, which can also be identified by the identification module 2.

The identification module 2 sequentially identifies the product code and the tag code on the chosen product, and transmits the identification data of the product code and the identification data of the tag code to the analysis processing module 3. The analysis processing module 3 extracts attribute information of the chosen products, such as price, weight, etc., based on the received identification data. These attribute information may be stored in a local database or a cloud database.

If the identification module 2 fails to identify the product code, the analysis processing module 3 sends a corresponding command to the feedback module 5.

The feedback module 5 may remind the user, for example, by voice, to “RESCAN”. If the product code on the chosen product still fails to be identified after a predetermined time interval, for example, 5 seconds, the analysis processing module 3 sends a corresponding command to the feedback module 5.
The feedback module 5 may remind the user, for example, by voice, that “RESCAN FAILS” or “DO NOT BLOCK THE TAG”. In addition, the feedback module 5 may also remind the store staff, by voice or LED light, that “MANUAL SERVICE IS REQUIRED”.

If the identification module 2 successfully identifies the product code but fails to identify the tag code, the analysis processing module 3 sends a corresponding command to the feedback module 5. The feedback module 5 may remind the user, for example, by voice, to “RESCAN”. If the tag code on the chosen product still fails to be identified after a predetermined time interval, for example, 3 second, the chosen product is determined to be free of a tag, and the analysis processing module 3 then allows the next operation, such as pricing and checkout.

When the identification module 2 successfully identifies the product code and the tag code, the analysis processing module 3 transmits an altering command based on the received identification data to alter the tag on the chosen product, thereby enabling smooth checkout of the chosen product and allowing it to be taken out of the store.

However, in daily shopping, it is often the case that: after the tag on the chosen product is altered, the user does not want to buy the product at last; the user has chosen a plurality of products, for example, 3 pens, but only wants to buy 2 pens at the time of checkout. This brings up a series of problems: firstly, if the user is allowed to reduce the number of the chosen products arbitrarily at the time of checkout, it is not able to prevent the products from being stolen (as the tag has been altered, the user's behavior of reducing the number of the chosen products arbitrarily at the time of checkout cannot be monitored); however, if the user is forbidden to reduce the number of the chosen products at the time of checkout, the user will be unable to complete the checkout, which greatly affects the user experience; secondly, the chosen products whose tags have been altered, need to be retrieved and tagged again, which increases the difficulty in maintenance of the store.

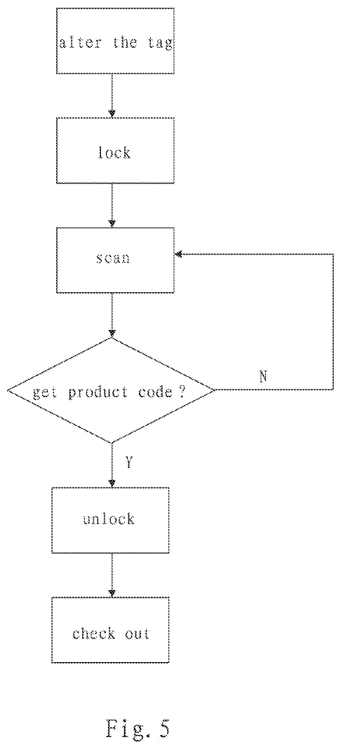

Next, a method for operating the self-service shopping system 1 according a fourth embodiment of the present invention is shown with reference to FIG. 5. In the fourth embodiment, when receiving the identification data of the product code on the chosen product and determining that the chosen product carries a tag, the analysis processing module 3 transmits an altering command to the altering module 4. Accordingly, the altering module 4 is configured to alter the tag on the chosen product based on the altering command of the analysis processing module 3. After the tag has been altered, the analysis processing module 3 generates a lock command to lock the number of the chosen products with tags and prevent the user from arbitrarily altering the number of the chosen products with tags. In other words, the user is unable to change the number of the chosen products (the chosen products carrying altered tags) on the interactive interface.

In order to improve the user's experience, if the user wants to reduce the number of the chosen product carrying the altered tag, he/she needs to rescan the chosen product. When the identification module 2 identifies the product code on the chosen product again, the analysis processing module 3 generates an unlock command to allow the user to reduce the number of the chosen product carrying the altered tag through the interactive interface of the self-service shopping system. Therefore, the user can perform the checkout operation according to his/her actual needs, thereby improving the user experience.

Further, the self-service shopping system 1 may further include a retrieving device. The user may place unneeded products in the retrieving device. Alternatively, when the identification module 2 (which may additionally be disposed within the retrieving device) identifies again the product code on the chosen product carrying the altered tag, the retrieving device is configured to retrieve the chosen product carrying the altered tag. Alternatively, if the user has reduced the number of the chosen product carrying the altered tag, the store staff are notified by LED display or voice to retrieve and re-tag the chosen products. As a result, the daily maintenance of the store is simplified, and the shopping efficiency of the user is greatly improved.

Although the exemplary embodiments of the present invention have been described, a person skilled in the art should understand that, multiple changes and modifications may be made to the exemplary embodiments without substantively departing from the spirit and scope of the present invention. Accordingly, all the changes and modifications are encompassed within the protection scope of the present invention as defined by the claims. The present invention is defined by the appended claims, and the equivalents of these claims are also contained therein.

1. A method for operating a self-service shopping system, comprising:
identifying a product code on a chosen product;
determining whether the chosen product carries a tag;
if the product code on the chosen product is identified and the chosen product is determined to carry a tag, altering the tag on the chosen product; and
when the product code on the chosen product carrying the altered tag is identified again, allowing a user to reduce the number of the chosen product carrying the altered tag through an interactive interface of the self-service shopping system or store staff.

2. The method according to claim 1, further comprising: if the product code on the chosen product is identified and the chosen product is determined to carry no tag, allowing the chosen product to be priced.

3. The method according to claim 1, further comprising: identifying a tag code on the chosen product, and altering the tag on the chosen product if the product code and the tag code on the chosen product are both identified.

4. The method according to claim 3, wherein the step of altering the tag on the chosen product if the product code and the tag code on the chosen product are both identified includes: checking, based on database, whether the product code and tag code identified have a correspondence relationship, and if so, altering the tag on the chosen product, or otherwise, feeding a result of altering failure back to a user and/or store staff.

5. The method according to claim 3, further comprising:
performing another identification at least once if at least one of the product code and the tag code on the chosen product fails to be identified; and
feeding a result of altering failure back to a user and/or store staff if the product code and the tag code on the chosen product still fail to be identified after a first predetermined time interval.

6. The method according to claim 1, further comprising:
performing another identification at least once if the chosen product is determined to carry a tag but the product code on the chosen product fails to be identified; and
feeding a result of altering failure back to a user and/or store staff if the product code on the chosen product still fails to be identified after a third predetermined time interval.

7. A self-service shopping system, comprising an identification module, an analysis processing module and an altering module, wherein the identification module is configured to identify a product code on a chosen product, and transmit identification data to the analysis processing module; the analysis processing module is configured to:
determine whether the chosen product carries a tag;
transmit an altering command to the altering module when the identification module successfully identifies the product code on the chosen product and the analysis processing module determines that the chosen product carries a tag;
allow the user to reduce the number of the chosen product carrying altered tag through an interactive interface of the self-service shopping system or store staff when the identification module successfully identifies again the product code on the chosen product carrying the altered tag; and
the altering module is configured to alter the tag on the chosen product based on the altering command of the analysis processing module.

8. The self-service shopping system according to claim 7, wherein the self-service shopping system has a tag detector configured to detect the tag on the chosen product and transmit a detection signal to the analysis processing module, which, based on the detection signal, determines whether the chosen product carries a tag.

9. The self-service shopping system according to claim 7, wherein if the identification module successfully identifies the product code on the chosen product and the analysis processing module determines that the chosen product carries no tag, the analysis processing module allows the chosen product to be priced.

10. The self-service shopping system according to claim 7, wherein the identification module is further configured to identify a tag code on the chosen product, and the analysis processing module is further configured such that if the identification module successfully identifies the product code and the tag code on the chosen product, the altering module alters the tag on the chosen product.

11. The self-service shopping system according to claim 10, wherein the analysis processing module checks, based on database, whether the product code and tag code identified have a correspondence relationship, and if so, the altering module alters the tag on the chosen product, or otherwise, the altering operation fails.

12. The self-service shopping system according to claim 10, wherein the identification module is configured to perform another identification at least once if it fails to identify at least one of the product code and the tag code on the chosen product;
and if the product code and the tag code on the chosen product still fail to be identified after a first predetermined time interval, the altering operation fails, and the analysis processing module controls a feedback module of the self-service shopping system such that the feedback module feeds the information on failure of altering back to the user and/or store staff via voice output and/or visual output.

13. A method for operating a self-service shopping system, comprising:
receiving identification data of a product code on a chosen product;
determining whether the chosen product carries a tag;
if the identification data of the product code on the chosen product is received and the chosen product is determined to carry a tag, sending an altering command to alter the tag on the chosen product; and
when the identification data of the product code on the chosen product carrying altered tag is received again, sending an unlocking command to a upper communication module to allow a user to reduce the number of the chosen product carrying the altered tag through an interactive interface of the self-service shopping system or store staff.

14. The method according to claim 13, wherein the step of determining whether the chosen product carries a tag includes receiving a detection signal of a tag detector for detecting whether the chosen product carries a tag.

15. The method according to claim 13, further comprising: if the product code on the chosen product is received and the chosen product is determined to carry no tag, sending a command to the upper communication module to allow the chosen product to be priced.

16. The method according to claim 13, further comprising: receiving identification data of a tag code on the chosen product, and if the identification data of the product code and the identification data of the tag code on the chosen product is received, sending a command to a lower communication module to alter the tag on the chosen product.

17. The method according to claim 13, wherein the step of, if the identification data of the product code on the chosen product is received and the chosen product is determined to carry a tag, sending an altering command to alter the tag on the chosen product includes: if the received identification data of the product code and identification data of the tag code on the chosen product have a correspondence relationship, sending an altering command to alter the tag on the chosen product; and if no corresponding relationship is present therebetween, sending a control signal to feed a result of altering failure to a user and/or store staff.

18. The method according to claim 13, further comprising:
sending a command to a lower communication module to cause the lower communication module to perform another identification at least once if at least one of the identification data of the product code and the identification data of the tag code on the chosen product fails to be identified; and
sending a control signal to feed a result of altering failure to a user and/or store staff if the identification data of the product code and the identification data of the tag code on the chosen product still fail to be received after a first predetermined time interval.

19. The method according to claim 13, further comprising:
sending a command to a lower communication module to cause the lower communication module to perform another identification at least once if the identification data of the product code on the chosen product is received while the identification data of the tag code on the chosen product fails to be received; and
determining the chosen product to carry no tag if the identification data of the tag code on the chosen product still fails to be received after a second predetermined time interval, and then sending a command to the upper communication module to allow the chosen product to be priced.

20. The method according to claim 13, further comprising:
sending a command to a lower communication module to cause the lower communication module to perform another identification at least once if the chosen product is determined to carry a tag carry a tag but no identification data of the product code on the chosen product is received; and
sending a control signal to feed a result of altering failure to a user and/or store staff if the identification data of the product code on the chosen product still fails to be received after a third predetermined time interval.
